(19) United States
(12) Patent Application Publication
(10) Pub. No.: US 2025/0264114 A1
(43) Pub. Date: Aug. 21, 2025

(54) ROTOR FAN

(71) Applicant: Mubea Carbo Tech GmbH, Salzburg (AT)

(72) Inventors: Stefan SCHEIBLHOFER, Graz (AT); Konstantin VARBENOV, Graz (AT); Lisa TRANNINGER, Freilassing (DE); Marc Linus FECHER, Laufen (DE)

(73) Assignee: Mubea Carbo Tech GmbH, Salzburg (AT)

(21) Appl. No.: 18/881,530

(22) PCT Filed: Jun. 27, 2023
(86) PCT No.: PCT/EP2023/067446

§ 371 Date: Jan. 6, 2025

(30) Foreign Application Priority Data
Jul. 8, 2022 (CH) CH000817/2022
Dec. 1, 2022 (CH) CH001437/2022

(51) Int. Cl. F04D 29/38; F04D 29/32

(52) U.S. Cl. CPC F04D 29/388; F04D 29/329; F05D 2300/603

(57) ABSTRACT

The present disclosure relates to a rotor fan (1) for an airborne vehicle, which comprises several rotor blades (2) arranged rotationally symmetric around a rotor axis (3). Each rotor blade (2) comprises a blade body (4) which is made of a composite material comprising reinforcing fibers (5) embedded in a matrix material (6) and extends in a longitudinal direction (7) between a bottom portion (8) and a top portion (9) and in transverse direction (10) between a leading edge (11) and a trailing edge (12). The rotor fan (1) further comprises a hub (13) with a hub body (13) which is at least partially made of a composite material comprising reinforcing fibers (14) embedded in a matrix material (15). The bottom portion (8) of each rotor blade (2) comprises a pedestal (17) which is at least partially embedded in the composite material of the hub (13).

### FIELD OF THE DISCLOSURE

The present disclosure relates to a rotor fan made of fiber reinforced composite materials and a method for production of such a rotor fan.

### BACKGROUND OF THE DISCLOSURE

US201916418147A1, first published in May 2019 on behalf of Safran Aircraft Engines, is directed to a rotor blade. The rotor blade comprises a blade body made of composite material that includes a fiber reinforcement densified by a matrix. The blade body extends in a longitudinal direction between a root or bottom portion and a tip or top portion an in transverse direction between a leading edge and a trailing edge. The fiber reinforcement of the blade body includes a first portion constituted by a plurality of yarn layers interlinked by three-dimensional or multilayer weaving. A second portion forms all or part of at least one leading edge or at least one trailing edge of the blade. The second portion includes a plurality of short fibers oriented in random manner. The yarns of the plurality of yarn layers of the first portion and the short fibers of the second portion being embedded in a matrix.

US2018147797A1, first published in May 2018 on behalf of Safran Aircraft Engines, is directed to a method of fabricating an airfoil element out of composite material. The method comprises the following method steps: Making a fiber preform being impregnated with resin. Polymerizing the resin with a matrix so as to obtain an airfoil element made of composite material comprising fiber reinforcement densified by a matrix. Fastening metal reinforcement on the composite material airfoil element, wherein the metal reinforcement being fastened on the airfoil element by rivets. The method further comprises, prior to impregnating the fiber preform with resin, inserting spacer elements between the fibers of the fiber preform and removing said spacer elements after the resin has been polymerized so as to form at least one passage between the fibers of the fiber reinforcement of the composite material airfoil element.

US2018128282A1, first published in May 2018 on behalf of Rolls Royce Nam Tech Inc., is directed to a composite turbomachine that comprises a hub comprised of fiber and resin and a plurality of blade assemblies. Each blade assembly comprises a blade, a base, and a tang. The plurality of blade assemblies are arranged circumferentially around the hub, each interlocking with an adjacent blade assembly and retained in position by the hub and a band overwrapping the respective tang of each of the plurality of blade assemblies.

### SUMMARY OF THE DISCLOSURE

The aviation industry nowadays demands rotor fans, which satisfy contradictory requirements like an integral design as well as an easy recyclability. Manufacturing rotor fans from plastic materials has the advantages that the underling processes usually allow the production of high volumes and at the same time offer a high degree of freedom regarding the geometry. For this reason, recent interest has been shown in substituting rotor components made of metallic materials with those made at least partially of lightweight composite materials. In addition to weighing less than metal components, rotor components fabricated from fiber reinforced composite materials may demonstrate improved thermal properties and may have lower material and manufacturing costs than metal components.

However, rotor components fabricated from composite materials tend to have drawbacks such as lower loading and stress tolerances. Nevertheless, as components and in particular rotor components in the aviation industry are subjected to high loads, many load cycled and temperature fluctuations, a high structural integrity is crucial. This poses the dilemma that usually material combinations have to be used, which are hard to recycle, or production processes have to be chosen which are not suitable for high volumes.

One objective of the present disclosure can therefore be seen in providing a rotor fan and a method for producing such a rotor fan, which allows an efficient mass production and satisfy the need for meeting high mechanical requirements.

In one aspect, the disclosure relates to a rotor fan for an airborne vehicle. The rotor fan typically comprises several rotor blades, which are arranged rotationally symmetric around a rotor axis. Good results can be achieved when the rotor blades are at least partially made of fiber reinforced composite material, which comprises reinforcing fibers that are embedded in a surrounding matrix material. The rotor blades each typically comprise a blade body, which extends in a longitudinal direction between a bottom portion and a top portion.

Given the high mechanical stress due to the high speed, acceleration forces as well as the potential impact of elements like bird intake, in combination with thermal and pressure related fluctuations, the selection of suitable materials is very limited. In particular with regard to the materials suitable as matrix material. Good results can be achieved when the blade body is made from a fiber reinforced composite material comprising specifically in the direction of the occurring load continuous fibers. Continuous fibers are to be understood as fiber that are substantially longer compared to their diameter. Good results can be achieved with fibers in the range of at least 20 mm or longer. In a variation, the continuous fibers can be arranged in an oriented manner. The fibers are preferably arranged essentially parallel to the longitudinal direction of the rotor blade.

Alternatively, or in addition the composite material of the blade body can comprise a number of fiber layers which are interconnected by three-dimensional or multilayer weaving. The fibers or layers of fibers can be prepared by a preforming process. The fibers can thereby be arranged by a tailored fiber placement process. Alternatively, or in addition also prefabricated fiber tapes can be used. To ensure that the layers of fibers stay in the desired arrangement, the fibers can be stitched together. In transverse direction the blade body extends between a leading edge and a trailing edge. The continuous fibers or layers of fibers can be already impregnated with a suitable composite material. Good results can be achieved with prepregs, which are fiber fabrics that have been pre-impregnated with resin.

In principle either thermoplastic materials and or thermosets, e.g. in form of resins can be used as matrix material. Depending on the geometry and desired properties the blade bodies can be made by a molding process, like a resin transfer molding process (RTM) or a molding process whereby the matrix material is plasticized, e.g. hot pressing or injected e.g. injection molding. In a variation, a hot pressing process can be used for making the blade bodies whereby the composite material of the blade bodies comprises continuous fibers, embedded in a matrix material. Good results can be achieved when a thermoplastic material out of the group of the polyaryletherketone (PAEK) family is used. E.g. polyether ether ketone (PEEK) which is a colourless organic thermoplastic polymer with excellent mechanical and chemical resistance properties that are retained to high temperatures. Thermoplastic materials out of the group of the polyaryletherketone (PAEK) family are among the few plastic materials, which are compatible with ultra-high vacuum applications, which makes them suitable for aerospace applications.

For an aerodynamically optimized design, the blade body can be spatially curved in transversal direction between the leading edge and the trailing edge. Alternatively, or in addition the blade body can also be wound with respect to the longitudinal direction between the bottom portion and the top portion. For further increasing the stability and the wear resistance, the blade body can comprise a reinforced leading edge. The reinforcement can be designed as an inlay or be applied on top or in between the fiber layers of the blade body. The inlay can be made as an insert and/or a bent sheet metal made e.g. of titanium. A good compromise between structural integrity and flexibility of the rotor blades can be obtained when the fiber to matrix ratio is between 2:1 and 1:1.

The rotor fan typically further comprises a hub with a hub body that is at least partially made of a composite material comprising reinforcing fibers embedded in a matrix material. Good results can be achieved when the reinforcing fibers of the hub are short fibers having a length in the range of 0.5 to 10 mm and being arranged in a non-oriented manner, e.g. by an injection molding process. The hub body can be designed as an annular sleeve, which is e.g. made by an injection molding process or a resin transfer process or a combination thereof. The hub is typically designed to interconnect several rotor blades to a shaft of an engine. Therefore, the bottom portion and/or a thereto interconnected pedestal of the respective blade body can be embedded in the matrix material of the hub body. The blade bodies between the respective bottom portion and the respective top portion of the rotor blades typically extend radially away from the hub.

Good results regarding an aerodynamically favorable design can be achieved, when the hub body has a conically outer surface. The outer surface is to be understood as the mantle surface of the hub body, which encircles the rotor axis and faces away from the rotor axis. Depending on the design of the rotor shaft, the center opening of the hub can have a staggered design. To allow an assembly of the rotor fan to a respective rotor shaft, the hub may comprise a bushing. The bushing can allow that the hub body can be attached to a rotor shaft by a frictional connection. Good results can be achieved when the hub body is shrink fitted onto the rotor shaft.

To allow a fast and reliable production of the hub body, the bushing can be overmolded together with the pedestals of the rotor blades in the same production step. The bushing and the pedestals of the rotor blades are preferably at least partially embedded in the composite material of the hub. To allow shrink fitting and the transmittal of forces between the hub body and the rotor shaft, the bushing can be e.g. made out of one of the following materials or a combination thereof: titanium, aluminum, steel.

To allow a fast production and at the same time a structurally rigid connection between the hub and the rotor blades, the bottom portion of each rotor blade typically comprises a pedestal which is at least partially embedded (encompassed) in the composite material of the hub. The pedestals are typically attached to the hub body by an adhesive, which may be provided by the matrix material of the hub body. To increase the mechanical load bearing capabilities of the hub body and therefore of the overall rotor fan, the hub body is typically made of a composite material which comprises reinforcing fibers. A good compromise between an efficient process and the desired mechanical stability can be achieved when the reinforcing fibers are short fibers. Short fibers are typically in the range between 0.5 mm and 10 mm, preferably between 3 mm and 5 mm. This allows an injection molding process wherein the fibers are mixed into the plasticized matrix material and injected into the mold together with the matrix material.

To ensure that the rotor blades stay attached to the hub body in a manner such that even under high loads or under the impact of an object, like bird intake in the air, no delamination takes place between the rotor blades and the hub body, the pedestals can be interconnected to the hub body by a form fit. Good results can be achieved when the aerodynamically designed rotor blades do comprise a pedestal at its bottom portion, which has an undercut. The pedestal can be designed as an essentially rectangular block that comprises an undercut in form of a recess.

In a variation, the recess extends at least partially along the pedestal in transverse of the respective rotor blade. The recess can be designed as an essentially V- or U-shaped channel. In a variation, the hub body has a conically outer surface. The pedestal can be wedge shaped to obtain a smooth transition between the top face of the pedestal and the surrounding outer surface of the hub body.

The top face of the pedestal is to be understood as the face facing towards the top portion of the rotor blade. For a smooth flow of forces from the hub body into the respective rotor blade, the rotor blade can merge into the pedestal with a transition area that creates a smooth transition between the blade body and the top face of the pedestal.

The adhesive bond between the pedestals and the hub is critical as this connection is subjected to dynamic loads, vibrations and bending loads which can cause a failure of the connection and as a result the rotor blade can be delaminated from the hub body. To prevent this failure, a geometry of the pedestal is desired which is both, favorable regarding the manufacturing process of the rotor blades and favorable regarding a stable connection with the hub body. As the pedestals are typically at least partially embedded in the hub body, a Y-shaped geometry has proven to be favorable. A Y-shaped pedestal comprises two legs which extend away from the bottom portion in an angled manner with respect to the longitudinal direction. Such a design allows that the continuous fibers or fiber layers of the hub body can run from the top portion all the way into the pedestal. The fiber layers of the two legs of the pedestal can be merged in the bottom portion and stacked and run in parallel from the bottom portion all the way up to the top portion within the blade body. The design allows that the reinforcing fibers can be well aligned in the mold during the manufacturing of the rotor blades and can be embedded in the hub body in a manner such that loads and bending loads can be well compensated and derived from the blade body into the hub body via the two legs.

Good results regarding a positionally accurate mounting can be achieved when the hub body is made of several parts. The hub body can comprise at least one ring, which is at least partially embedded in the composite material. The ring can be attached to the pedestals in a form fit connection before the pedestals and the ring are at least partially embedded in the matrix material of the hub body. The ring can be produced in a first production step and consist e.g. of continuous fibers being wound or interweaved with each other or metal or a combination thereof. The pedestals are typically inserted into respective slots of a mold, before the ring and the thereto attached rotor blades are overmolded. The slots allow a set-up wherein the rotor blades can be arranged positionally accurate in a rotationally symmetric manner around the rotor axis, before at least partially embedding the pedestals in the matrix material.

Good results regarding a torsionally rigid design can be achieved when the ring is interconnected to the pedestals in a form fit manner, e.g. in that it comprises several grooves, which face away from the rotor axis configured to receive at least one pedestal of a rotor blade. Arranging the pedestals within a respective groove of the ring improves the stability of the rotor fan, as it further increases the resistance against twisting of the rotor blades with respect to the rotor axis under load. In addition, arranging the pedestals within a respective groove of the ring positions the rotor blades with respect to the ring before the ring is embedded, e.g. by overmolding.

To additionally increase the connection between the rotor blades and the hub, the pedestals can comprise protrusions which engage with a recess of the ring. This form fit connection increases the connection of rotor blades and hub even under high pull-out forces. The grooves can each comprise at least one lateral recess which can receive a protrusion of the pedestals of one of the several rotor blades. In a variation, the protrusion can be spherical and protrude laterally away from the pedestal between the leading edge and the trailing edge. The ring can be arranged on the inside acting simultaneously as a bushing to allow an assembly of the rotor fan to a respective rotor shaft as described above and hereinafter. The blade bodies of the rotor blades can be bent between the respective leading edge and the trailing edge. In addition the blade bodies can also be bent between the top portion and the bottom portion in the section of the blade body which is embedded in the hub body, forming an undercut between respective blade body and the hub body. The undercut may increase the resistance of the blade bodies from being pulled out of the hub body under load.

For reducing the moment of inertia and therefore reducing the torque needed for the desired angular acceleration of the rotor fan, the hub body can be optimized regarding the geometry. In a variation, the hub body comprises an outer collar, an inner collar and a bridge connecting the two collars with each other. The outer collar can be designed to encompass the pedestals of the therein embedded blade bodies. The inner collar can be connected to the bushing. The bridge can be designed as an annular bead attached to the inner collar and connected to the outer collar.

An efficient production process, allowing the mass production and therefore high quantities, can be achieved by producing the individual blade bodies of the rotor blades by embedding the reinforcing fibers in a matrix material in a first mold. In a variation, each blade body is produced in a single cavity of the mold. The reinforcing fibers are preferably arranged in a first mold half of the mold together with the matrix material, before a second mold half is connected to the first mold half thereby forming a cavity. The reinforcing fibers and the matrix material are typically connected to each into the cavity by a hot pressing process. Alternatively, the reinforcing fibers are placed in the first mold and after closing the mold plasticized matrix material is injected, thereby encompassing the reinforcing fibers. After curing the rotor blade, the blade can be removed from the mold and be grouped with a number of additional rotor blades, forming the outer contour of the rotor fan. The blade body and the thereto interconnected pedestal are typically made in an integral manner in a common molding process in the first mold. This has the advantage that an interface can be avoided, which avoids stress concentrations at the transition area between the blade body and the pedestal.

The known assembly processes for rotor fans with rotor blades made form a metallic material typically require the rotor blades being individually plugged into respective slots in a hub and have to be secured along the rotor axis. In comparison with the proposed method, several rotor blades can be arranged in a rotationally symmetric manner with respect to the rotor axis in a second mold and the pedestals of the rotor blades can at least partially embedded in the composite material of the hub in one process step.

Preferably, the rotor fan is made by a combination of two molding processes as briefly described hereinafter:
Making of individual rotor blades in a first mold by placing continuous fibers and matrix material in a cavity of the first mold and by closing the cavity of the first mold hot pressing the continuous fibers and matrix material and thereby encompassing the continuous fibers by the matrix material.
If appropriate at least one additional part can be arranged in the cavity of the first mold along with the continuous fibers. The at least one additional part later forming part of the rotor blade and being e.g. a leading edge or a reinforcing means or a combination thereof.
Removing of the rotor blade from the first mold after sufficiently curing of the matrix material.
Positioning of bottom portions of previously made rotor blades into thereto corresponding recesses adjacent to a cavity of a second mold arranged in an open position such that the rotor blades are arranged rotationally symmetric around an (imaginary) rotor axis of the rotor fan to be produced. The cavity corresponding at least partially to the hub body of the rotor fan.
Closing of the second mold such that the bottom portion of the rotor blades are encompassed in the cavity of the second mold.
Forcing of liquefied plastic material through an opening into the cavity of the second mold, thereby filling the empty space of the cavity and encompassing the bottom portion of the rotor blades arranged in the cavity. The liquefied plastic material usually comprises a matrix material and therein arranged comparatively short reinforcing fibers.
After curing of the plastic material, opening of the second mold and removing the assembled rotor fan. After curing, the short reinforcing fibers in the hub body are usually arranged in a random manner based on the flow of the material when distributing in the cavity during injection.
If appropriate at least one additional part can be arranged in the cavity of the second mold before entering the material. The at least one additional part forming part of the rotor fan being e.g. an edge or a bushing or a ring or a reinforcing means or a combination thereof. The additional part can be made of composite material, e.g. in the case of an at least partially embedded reinforcing ring, or metal or a combination thereof.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE DRAWINGS

The herein described disclosure will be more fully understood from the detailed description given herein below and the accompanying drawings which should not be considered limiting to the disclosure described in the appended claims. The drawings are showing:

FIG. 1 A first variation of the rotor fan in a perspective view from the front and above;

FIG. 2 The variation of the rotor fan according to FIG. 1 in a perspective view from the back and above;

FIG. 3 The variation of the rotor fan according to FIG. 1 in a perspective and exploded view from the front and above;

FIG. 4 The variation of the rotor fan according to FIG. 1 in a perspective view with a partial cut-out from the front and above;

FIG. 5 A first variation of a rotor blade in a perspective view showing a first lateral side of the rotor blade;

FIG. 6 The variation of the rotor blade according to FIG. 4 in a perspective view showing the opposite lateral side of the rotor blade with a partial cut-out;

FIG. 7 A second variation of the rotor blade in a perspective and exploded view with stacked fiber layers;

FIG. 8 A first mold with therein arranged reinforcing fibers in an exploded view in a perspective view from the front and above;

FIG. 9 The first mold with therein arranged finished rotor blade in an exploded view in a perspective view from the front and above on;

FIG. 10 A second mold with therein arranged rotor blades in a perspective view from the front and above;

FIG. 11 A schematic sectional view of a third variation of the rotor blade with an Y-shaped pedestal;

FIG. 12 A second variation of the rotor fan in a perspective view from the front and above (FIG. 12a) and the back and above (FIG. 12b);

FIG. 13 The rotor blades of the variation of the rotor fan according to FIG. 12 in a front view;

FIG. 14 The rotor blades of the variation of the rotor fan according to FIG. 12 in a front view with the pedestals being arranged in the ring;

FIG. 15 The rotor blades of the variation of the rotor fan according to FIG. 12 in a front view partially embedded in the hub body;

FIG. 16 A fourth variation of the rotor blade in a lateral view (FIG. 16a) and a front view (FIG. 16b);

FIG. 17 The variation of the rotor blade according to FIG. 16 arranged in the ring;

FIG. 18 The second variation of the rotor fan in a perspective view from the front and above and partially cut.

### DESCRIPTION OF THE EMBODIMENTS

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

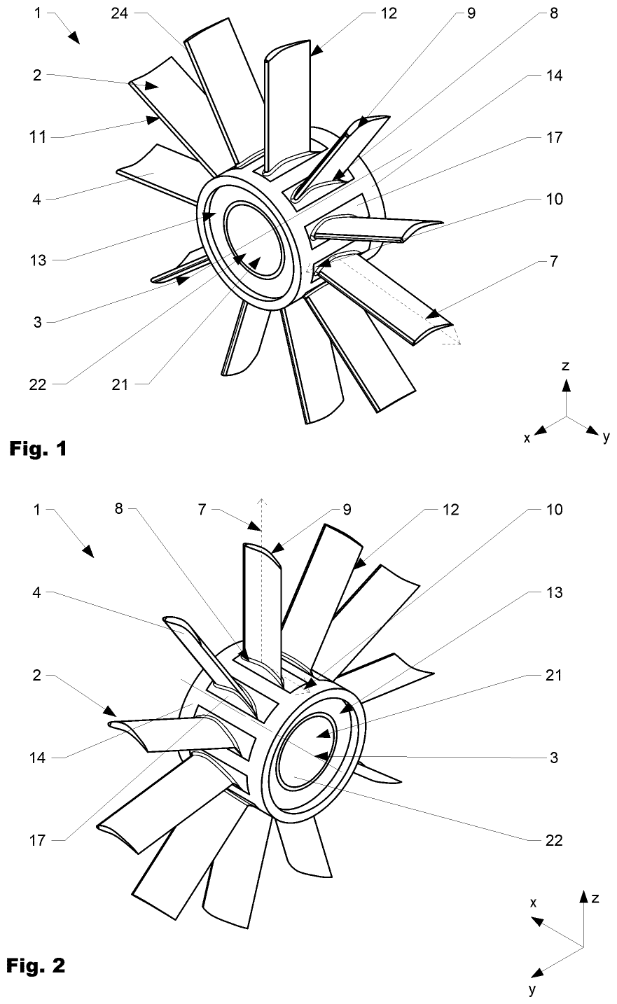

FIGS. 1 to 4 show a first variation of the rotor fan 1. The shown variation of the rotor fan 1 is designed for airborne vehicles. The shown rotor fan 1 typically comprises several rotor blades 2, which are arranged rotationally symmetric with respect to the rotor axis 3. The rotor blades 2 are made of a composite material, which comprises reinforcing fibers 5 embedded in a matrix material 6. The blade body 4 typically extends in a longitudinal direction 7 between a bottom portion 8 and a top portion 9. Good results can be achieved when the blade body 4 is made from a fiber reinforced composite.

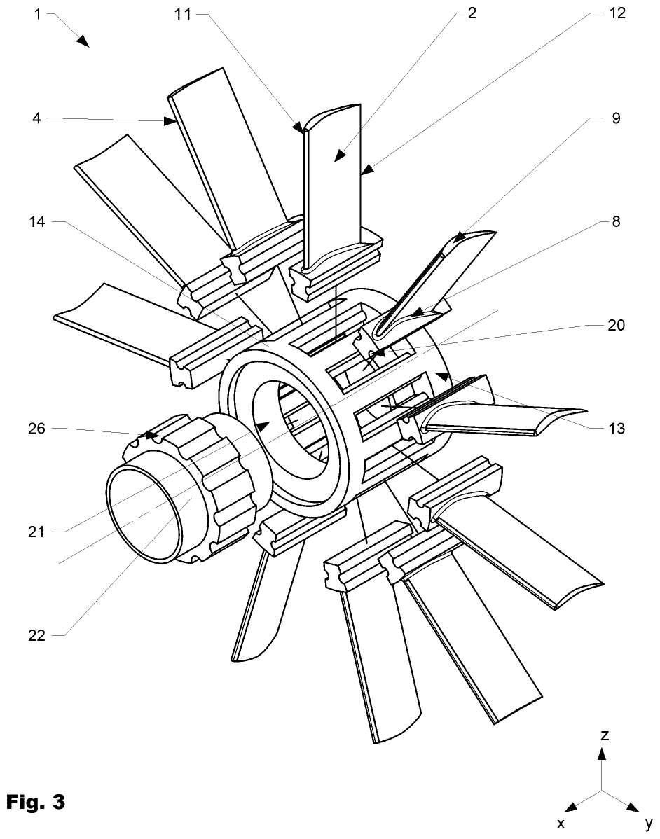

As can be obtained from FIG. 3, the shown variation of the rotor fan 1 comprises a hub 13 with a hub body 14, which is at least partially made of a composite material comprising reinforcing fibers 5 embedded in a matrix material 6. The shown hub body 14 is designed as an annular sleeve, which is typically made by an injection molding process. The individual rotor blades 2 are typically interconnected to the hub 13 by a molding process. The pedestals 17 of the previously made rotor blades 2 are arranged in an open position in a mold such that the rotor blades 2 are arranged rotationally symmetric around a central axis, typically corresponding to the later rotor axis 3 of the rotor fan 1 to be produced. For producing the hub body 14, liquefied plastic material is forced through an opening 33 into the cavity of the mold, thereby filling the empty space of the cavity and encompassing the pedestals 17 of the rotor blades 2 arranged in the cavity.

The liquefied plastic material usually comprises the matrix material 16 and therein arranged comparatively short reinforcing fibers 15. The shown rotor fan 1 comprises a bushing 22 with castellation 26. This allows that the hub body 14 can be attached to the rotor shaft by a frictional connection and the castellation allows a strong interconnection, preventing a delamination in circumferential direction between the bushing 22 and the matrix material 16 due to the transmitted torque. To ensure that the rotor blades 2 stay attached to the hub body 14 in a manner such that even under high loads or under the impact of an object, like bird intake in the air, no delamination takes place between rotor blades 2 and hub body 14, the pedestals 17 can be interconnected to the hub body 14 by a form fit. Good results regarding a stable interconnection between the blade bodies 4 and the hub body 14 can be achieved when the rotor blades 2 do comprise a pedestal 17 at its bottom portion, which has a geometry that comprises an undercut 20. The pedestal 17 can be designed as an essentially rectangular block which comprises an undercut 20 in form of a recess.

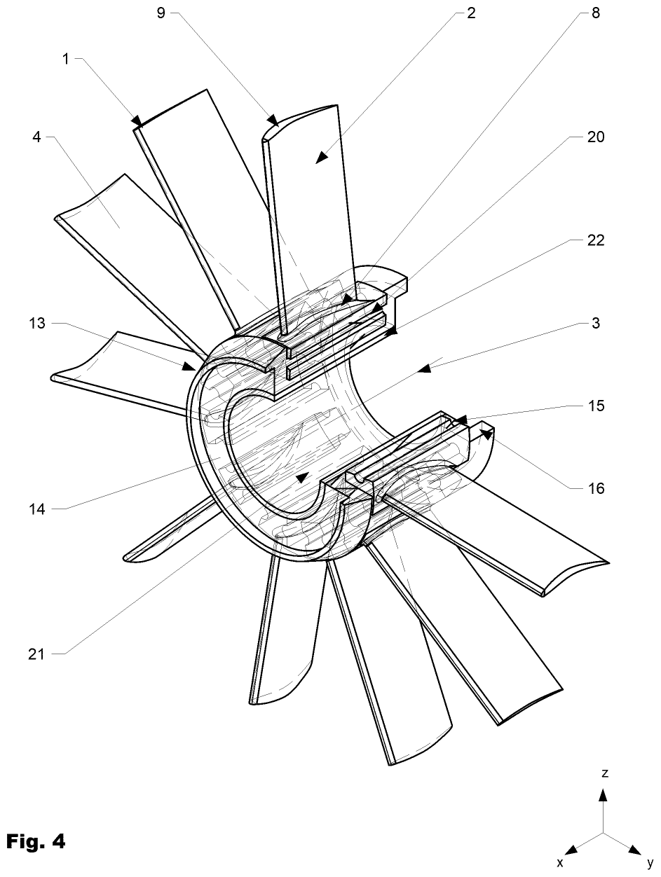

As can be obtained from FIG. 4, good results regarding an aerodynamically favorable design can be achieved, when the hub body 14 has a conically outer surface. The outer surface is to be understood as the mantle surface of the hub body 14 which encircles the rotor axis 3 and faces away from the rotor axis 3. Depending on the design of the rotor shaft, the center opening 21 of the hub 13 can have a staggered design. To allow an assembly of the hub body 14 to a respective rotor shaft, the shown hub body 14 comprises a bushing 22.

Good results can be achieved when the hub body 14 is shrink fitted onto the rotor shaft. To allow a fast and reliable production of the hub body 14, the bushing 22 is typically overmolded together with the pedestals 17 of the rotor blades 2. The bushing 22 and the pedestals 17 of the rotor blades 2 are at least partially embedded in the composite material of the hub 13. To allow shrink fitting and the transmittal of forces between the hub body 14 and the rotor shaft, the hub body 14 is typically made out of one of the following materials or a combination thereof: titanium, aluminum, steel. The reinforcing fibers 15 of the hub body 14 can be short fibers. Short fibers are typically in the range between 1 mm and 10 mm, preferably between 3 mm and 5 mm. This allows to mix in the reinforcing fibers 15 into the plasticized matrix material 16 and inject them into the mold together with the matrix material 16.

To allow a fast production and at the same time a structurally rigid connection between the hub 13 and the rotor blades 2, the bottom portion 8 of each rotor blade 2 typically comprises a pedestal 17 which is at least partially embedded in the composite material of the hub 13. The pedestals 17 are typically attached to the hub body 14 by an adhesive, which may be provided by the matrix material 16 of the hub body 14. Typically the hub body 14 is made by an injection molding process. To increase the mechanical load bearing capabilities of the hub body 14 and therefor of the overall rotor fan 1, the hub body 14 is typically made of a composite material which comprises reinforcing fibers 15.

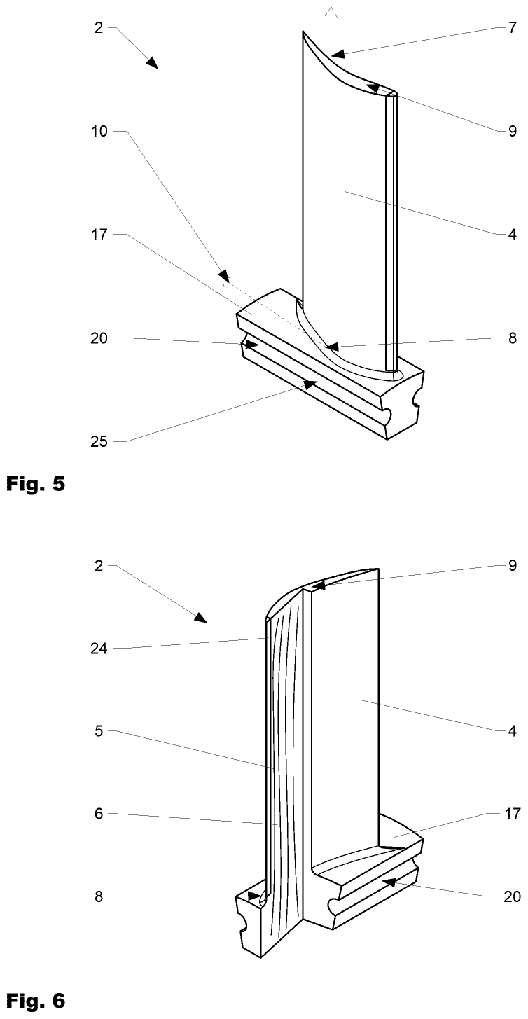

FIGS. 5 to 6 show a first variation of the rotor blade 2. The shown rotor blade 2 comprises a composite material with continuous fibers 5 embedded in a matrix material 6 made of polyether ether ketone (PEEK). Depending on the design of the rotor blade 2, the blade body 4 can comprises continuous fiber material. Alternatively, or in addition the blade body 4 can also comprise fiber fabrics and/or fiber scrims. In transverse direction 10 the blade body 4 extends between a leading edge 11 and a trailing edge 12. For further increasing the stability and the wear resistance, the blade body 4 can comprise a reinforced leading edge 11. The reinforcement of the leading edge 11 can be designed as a reinforcing element 24 in form of an inlay which is applied on top or in between the fiber layers of the blade body 4. The inlay can be made as an insert or bent sheet metal made of titanium.

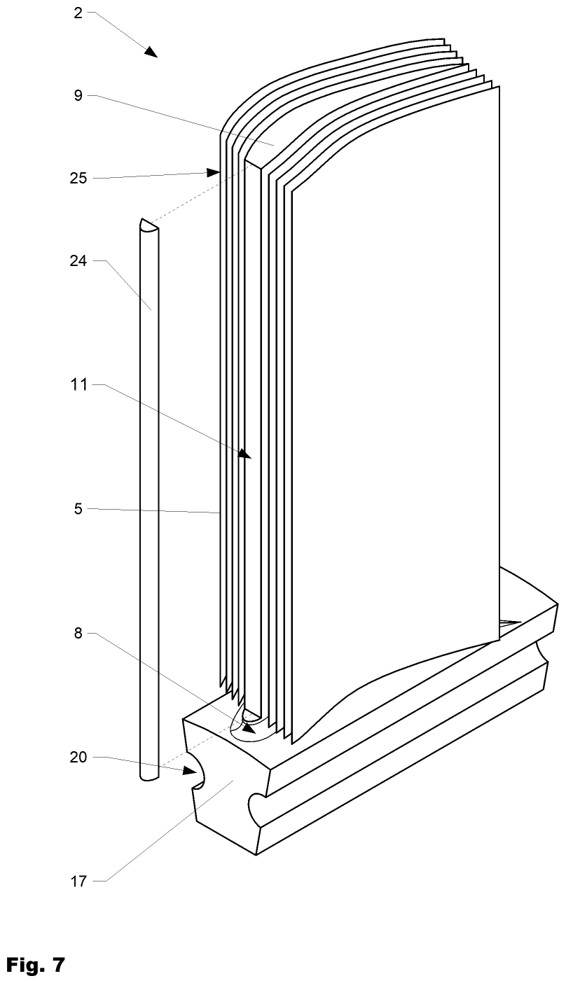

As can be obtained from FIG. 7, the shown composite material of the blade body 4 comprises a number of fiber layers 25, which are either interconnected by three-dimensional or multilayer weaving or stacking. In transverse direction 10 the shown blade body 4 extends between a leading edge 11 and a trailing edge 12. The shown blade body 4 comprises a reinforced leading edge. The reinforcement is designed as an inlay. In a variation, the undercut 20 of the pedestal 17 can be designed as a recess extends in transverse direction between the leading edge 11 and the trailing edge 12 of the respective rotor blade 2.

The recess can be designed as an essentially V-shaped channel. In a variation with a hub body 14 with a conically outer surface the pedestal 17 can be wedge shaped to obtain a smooth transition between the top face of the pedestal 17 and the surrounding outer surface of the hub body 14. The top face of the pedestal is to be understood as the face facing towards the top portion 9 of the rotor blade 2. For a smooth flow of forces from the hub body 14 into the respective rotor blade 2, the rotor blade 2 can merge into the pedestal with a transition area which creates a smooth transition between the blade body 4 and the top face of the pedestal 17.

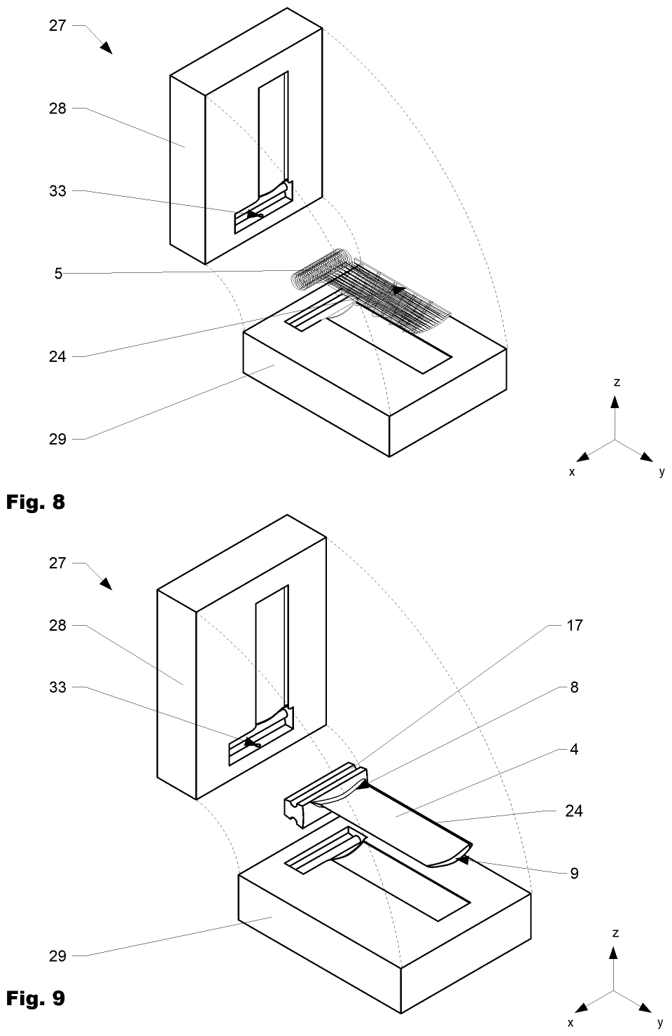

FIGS. 8 and 9 show the first molding process for the production of the rotor blades for the rotor fan 1. The rotor fan 1 is typically made by two subsequent molding processes. As can be obtained from FIG. 8, the individual rotor blades 2 are made in a first mold 27 by placing continuous reinforcing fibers 5 in a cavity of the first mold 27 formed by a first mold half 28 and a second mold half 29. The blade body 4 is either made by placing the reinforcing fibers 5 into the first mold 27 together with the matrix material 6 and hot pressing the reinforcing fibers 5 and the matrix material 6, which matrix material 6 is thereby plasticized and encompasses the reinforcing fibers 5. Alternatively, after closing the cavity of the first mold 27 the continuous fibers 5 can be encompassed by a matrix material 6, which is forced into the closed cavity of the first mold 27 through an opening 33 in a plasticized state, e.g. by an injection molding process. As can be obtained best from FIG. 9, after sufficiently curing of the matrix material 6 the respective rotor blade 2 is removed from the first mold 27. If appropriate at least one additional part can be arranged in the cavity of the first mold 27 along with the continuous reinforcing fibers 5. The at least one additional part later forming part of the rotor blade 2 and being e.g. a leading edge 11 or a reinforcing element 24 or a combination thereof.

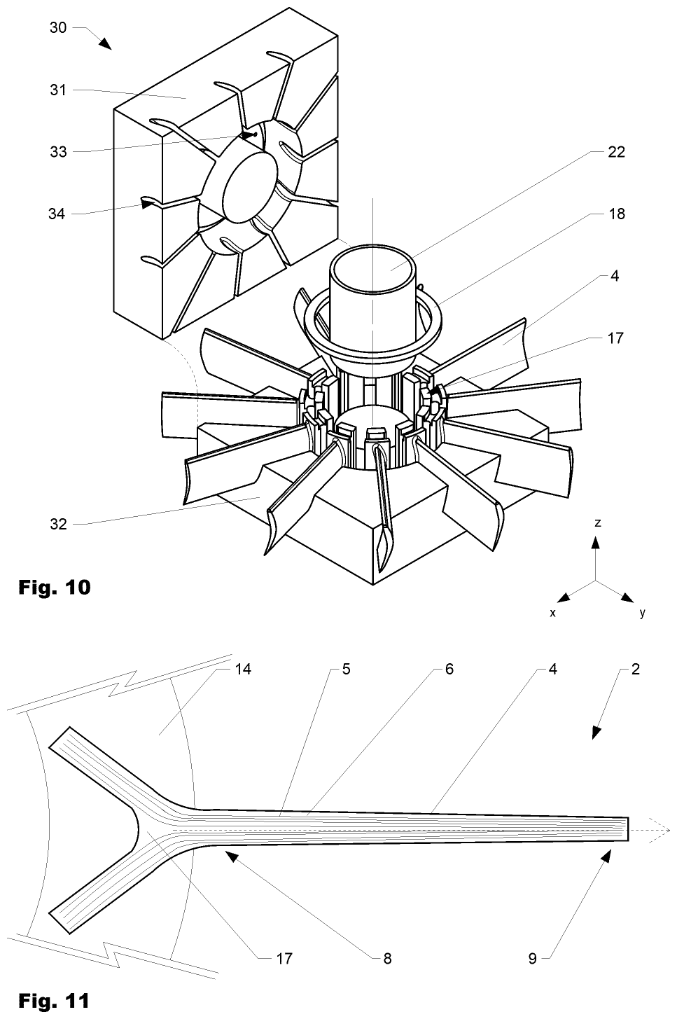

FIG. 10 shows the second molding process for the production of the rotor fan 1. The pedestals 17 of the previously made rotor blades 2 are placed into thereto corresponding recesses 34 adjacent to a cavity of a second mold 30. The recesses 34 are arranged in the second mold 30 such that in an open position the rotor blades 2 are arranged rotationally symmetric around a center axis which corresponds to the rotor axis 3 of the rotor fan 1 to be produced.

The cavity corresponds at least partially to the hub body 14 of the rotor fan 1. After closing the cavity of the second mold 30 the pedestals of the rotor blades are encompassed in the cavity of the second mold 30 between the first mold half 31 and the second mold half 32. Liquefied matrix material is forced through the opening 33 into the cavity of the second mold 30, thereby filling the empty space of the cavity and encompassing the pedestals 17 of the rotor blades 2 arranged in the cavity. The matrix material 16 of the hub body 14 is usually made from a plastic material which is liquefied and usually comprises therein arranged comparatively short reinforcing fibers 15.

After curing of the matrix material 16, the second mold 30 is opened and the assembled rotor fan 1 is removed. After curing, the short reinforcing fibers 16 in the hub body 14 are usually arranged in a random manner based on the flow of the material when distributing in the cavity during injection. If appropriate at least one additional part can be arranged in the cavity of the second mold before entering the material. The at least one additional part forming part of the rotor fan 1 can be the bushing 22 or a ring 18 or a reinforcing element 24 or a combination thereof. The additional part can be made of composite material, e.g. in the case of an at least partially embedded reinforcing ring 18, or metal or a combination thereof.

FIG. 11 shows a variation of the rotor blades 2 with a Y-shaped pedestal 17. The shown Y-shaped pedestal 17 comprises two legs, which extend away from the bottom portion 8 of the blade body 4 in an angled manner with respect to the longitudinal direction 7. Such a design allows that the reinforcing fibers 5 of the blade bodies 4 in form of continuous fibers or fiber layers 25 can run from the top portion 9 all the way into the pedestal 17. The fiber layers of the two legs of the pedestal 17 can be merged in the bottom portion 8 and stacked between the bottom portion 8 and the top portion 9. The reinforcing fibers 5 can run in parallel from the bottom portion 8 all the way up to the top portion 9 within the blade body 4. The adhesive bond between the pedestals 17 of the rotor blades 2 and the hub 13 is especially critical as the dynamic load of the rotor blades 2 and the resulting vibrations and bending loads can cause a failure of the connection and as a result in the rotor blade 2 breaking off from the hub body 4. A Y-shaped geometry has proven to be favorable as this geometry allows that the reinforcing fibers 5 in form of continuous fibers or as shown in form of fiber layers 25 can be well aligned in the mold during the manufacturing process of the rotor blades 2. When being embedded in the hub body 14 the Y-shaped pedestals are beneficial for deriving side loads and bending forces into the hub body 14.

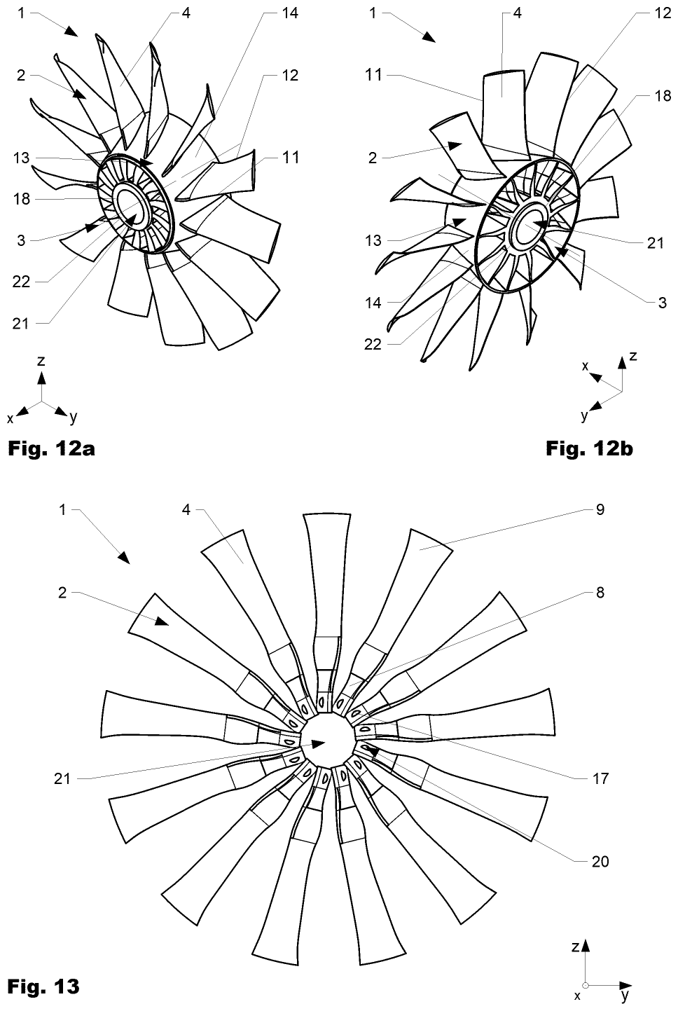

FIGS. 12 to 14 and FIG. 18 show a second variation of the rotor fan 1. Similar to the first variation, the second variation of the rotor fan 1 is likewise designed for airborne vehicles. The shown rotor fan 1 comprises several rotor blades 2, which are arranged rotationally symmetric with respect to the rotor axis 3. The rotor blades 2 are made of a composite material, which comprises reinforcing fibers 5 embedded in a matrix material 6. The blade body 4 typically extends in a longitudinal direction 7 between a bottom portion 8 and a top portion 9 with the bottom portion 8 with thereto interconnected pedestal 17 being partially embedded in the hub body 14.

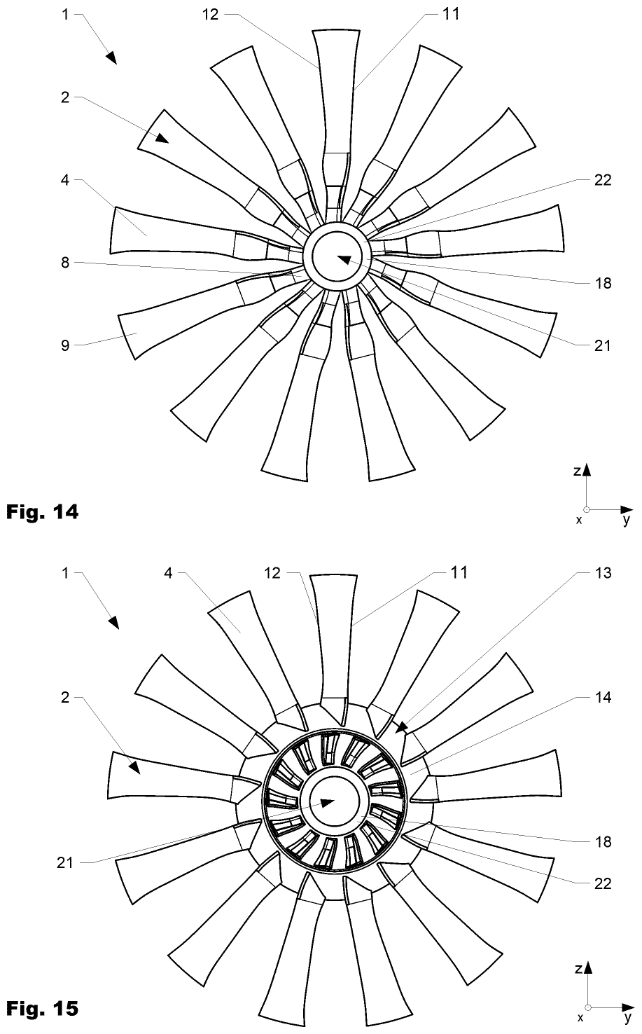

As can be obtained best from FIG. 13, the pedestals 17 of the blade bodies 4 each comprise protrusions 37, which laterally protrude away from the blade body 4 between the leading edge 11 and the trailing edge 12. During assembly the pedestals 17 of the blade bodies 4 are arranged in a ring 18, as can be obtained best from FIG. 14. The shown ring 18 comprises several grooves 35, which face away from the rotor axis 3 and are each configured to receive a pedestal 17 of one of the several rotor blades 2. Arranging the pedestals 17 within a respective groove 35 of the ring 18 improves the stability of the rotor fan 1, as it further increases the resistance against twisting of the rotor blades 2 with respect to the rotor axis 3 under load. After arranging the pedestals 17 of the rotor blades 2 in the ring 18, which can be integral with the bushing 22, the pre-assembled rotor fan 1 is placed in a mold and overmolded. As can be obtained best from FIG. 15 and the partially cut view shown in FIG. 18, the bottom portion 8, pedestal 17 and ring 18 are overmolded and at least partially embedded in the hub body 14.

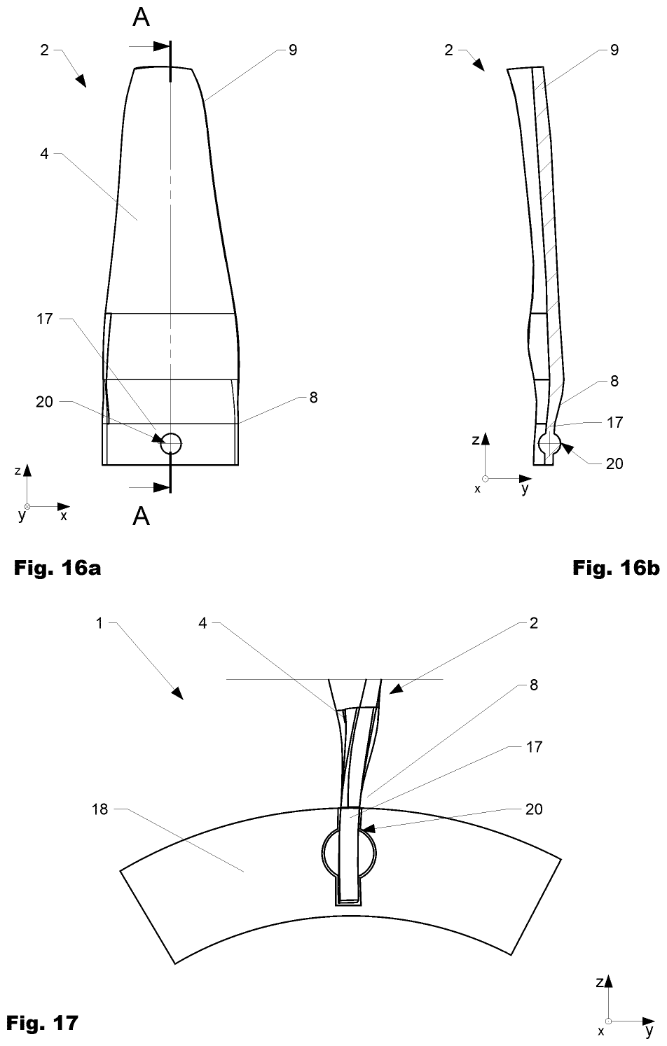

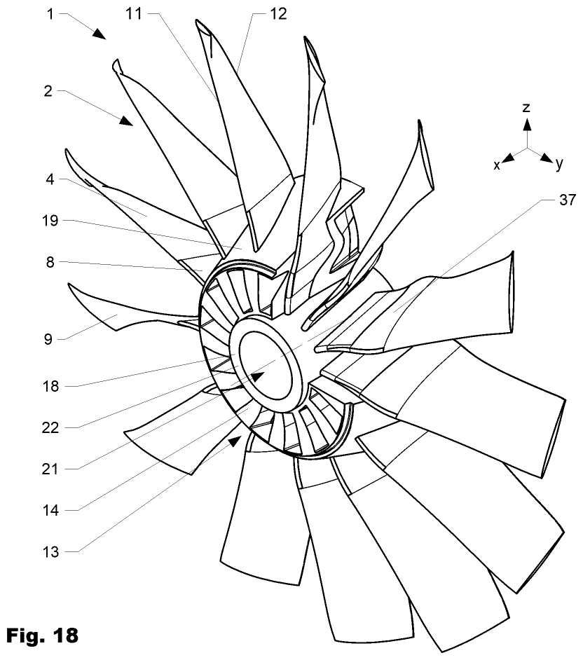

FIGS. 16 and 17 show a fourth variation of the rotor blade 2. In the mounted state the shown variation of the rotor blade 2 is mounted in a ring 18. The shown ring 18 comprises several grooves 35, which face away from the rotor axis 3 and are each configured to receive a pedestal 17 of one of the several rotor blades 2. The shown pedestals 17 comprise protrusions 37, which engage with a recess 36 of the ring 18. This form fit connection increases the connection of rotor blades 2 and hub 13 even under high pull-out forces. The grooves 35 can each comprise at least one lateral recess 36 which is configured to receive a protrusion 37 of the pedestals 17 of one of the several rotor blades 2. In a variation, the protrusion 37 can be spherical and protrude laterally away from the pedestal 17 between the leading edge 11 and the trailing edge 12.

FIG. 18 shows the second variation of the rotor fan 1 in a perspective view from the front and above and partially cut. As can be obtained best from the cut-out, the shown rotor blade 2 is bent between the leading edge 11 and the trailing edge 12. In addition the blade body 4 is also bent between the top portion 9 and the bottom portion 8 in the section of the blade body 4 which is embedded in the hub body 14, thereby forming an undercut between the blade body 4 and the hub body 14. The undercut increases the resistance of the blade body 4 from being pulled out of the hub body 14 under load.

Rather, the words used in the specification are words of description rather than limitation, and it is understood that various changes may be made without departing from the Spirit and scope of the disclosure.

LIST OF DESIGNATIONS

| | |
|---|---|
| 1 | Rotor fan |
| 2 | Rotor blade |
| 3 | Rotor axis |
| 4 | Blade body (rotor blade) |
| 5 | Reinforcing fibers (blade body) |
| 6 | Matrix material (blade body) |
| 7 | Longitudinal direction (blade body) |
| 8 | Bottom portion |
| 9 | Top portion |
| 10 | Transverse direction (blade body) |
| 11 | Leading edge |
| 12 | Trailing edge |
| 13 | Hub |
| 14 | Hub body |
| 15 | Reinforcing fibers (hub body) |
| 16 | Matrix material (hub body) |
| 17 | Pedestal |
| 18 | Ring (hub body) |
| 19 | Outer surface |
| 20 | Undercut (pedestal) |
| 21 | Center opening (hub) |
| 22 | Bushing |
| 23 | Outer shell surface |
| 24 | Reinforcing element |
| 25 | Fiber layer |
| 26 | Castellation |
| 27 | First mold |
| 28 | First mold half (first mold) |
| 29 | Second mold half (first mold) |
| 30 | Second mold |
| 31 | First mold half (second mold) |
| 32 | Second mold half (second mold) |
| 33 | Opening |
| 34 | Recess |
| 35 | Groove (ring) |
| 36 | Recess (ring) |
| 37 | Protrusion |

1. A rotor fan for an airborne vehicle comprising
a. several rotor blades arranged rotationally symmetric around a rotor axis, wherein each rotor blade comprises a blade body which is made of a composite material comprising reinforcing fibers embedded in a matrix material and extends
i. in a longitudinal direction between a bottom portion and a top portion, and
ii. in transverse direction between a leading edge and a trailing edge, and
b. a hub comprising a hub body made at least partially of composite material comprising reinforcing fibers embedded in a matrix material, wherein
c. the bottom portion of each rotor blade comprises a pedestal which is at least partially embedded in the composite material of the hub.

2. The rotor fan according to claim 1, wherein the pedestals of the rotor blades are attached to the hub body by an adhesive.

3. The rotor fan according to claim 2, wherein the adhesive is provided by the matrix material of the hub body.

4. The rotor fan according to claim 1, wherein the pedestals are interconnected to the hub body by a form fit.

5. The rotor fan according to claim 4, wherein the hub body comprises at least one ring which is at least partially embedded in the composite material of the hub body and the pedestals are interconnected to the ring by a form fit.

6. The rotor fan according to claim 5, wherein the ring comprises several grooves facing away from the rotor axis each receiving a pedestal of one of the several rotor blades.

7. The rotor fan according to claim 6, wherein the grooves each comprise at least one lateral recess, receiving at least one protrusion of the pedestals of one of the several rotor blades.

8. The rotor fan according to claim 7, wherein the at least one protrusion is spherical and protrudes laterally away from the pedestal between the leading edge and the trailing edge.

9. The rotor fan according to claim 1, wherein the blade body comprises continuous fibers being arranged essentially parallel with respect to the longitudinal direction of the blade body.

10. The rotor fan according to claim 1, wherein the leading edge of the blade body comprises a reinforcing element.

11. The rotor fan according to claim 1, wherein the composite material of the hub body comprises short fibers being mixed into the matrix material.

12. The rotor fan according to claim 1, wherein the hub body has a conically outer surface.

13. The rotor fan according to claim 1, wherein the center opening of the hub has a staggered design.

14. The rotor fan according to claim 1, wherein the hub comprises a bushing having a castellated design on the outer shell surface.

15. The rotor fan according to claim 1, wherein the hub comprises a bushing made out of one of the following materials or a combination thereof: titanium, aluminum, steel.

16. A method for producing the rotor fan according to claim 1, comprising the following steps:
a. Positioning the pedestals of previously made rotor blades into thereto corresponding recesses adjacent to a cavity of a second mold arranged in an open position such that the rotor blades are arranged rotationally symmetric around a rotor axis of the rotor fan to be produced;
b. Closing of the second mold such that the pedestals of the rotor blades are encompassed in the cavity of the second mold;
c. Forcing of liquefied matrix material through an opening into the cavity of the second mold, thereby filling the empty space of the cavity and encompassing the pedestals of the rotor blades arranged in the cavity;
d. After curing of the matrix material, opening of the second mold and removing the rotor fan.

17. The method for producing the rotor fan according to claim 16, wherein the individual rotor blades are made in a first mold by placing reinforcing fibers and matrix material in a cavity of the first mold and hot pressing the continuous fibers and matrix material whereby the plasticized matrix material encompasses the reinforcing fibers.

18. The method for producing the rotor fan according to claim 16, wherein the individual rotor blades are made in a first mold by placing reinforcing fibers in a cavity of the first mold and injecting plasticized matrix material into the mold which encompasses the reinforcing fibers.

19. The method for producing the rotor fan according to claim 16, wherein at least one additional part is placed in the cavity of the second mold before inserting the matrix material.

20. The method for producing the rotor fan according to claim 19, wherein the at least one additional part forming part of the rotor fan is a bushing or a ring or a reinforcing element or a combination thereof.

21. The method for producing the rotor fan according to claim 16, wherein the liquefied matrix material of the hub comprises short reinforcing fibers, which after curing are arranged in a random manner in the hub body.

22. The method for producing the rotor fan according to claim 16, wherein the blade body and the respective pedestal are made in an integral manner in a common molding process in the first mold.

23. The method for producing the rotor fan according to claim 16, wherein the rotor fan comprises a ring with thereto interconnected pedestals, wherein the ring is placed into the second mold before the composite material of the hub is overmolded.
